(19) United States
(12) Patent Application Publication
(10) Pub. No.: US 2025/0356467 A1
(43) Pub. Date: Nov. 20, 2025

(54) TECHNIQUES FOR TEMPORALLY CONSISTENT VIDEO RESTORATION USING LATENT DIFFUSION MODELS

(71) Applicant: DISNEY ENTERPRISES, INC., Burbank, CA (US)

(72) Inventors: Yang ZHANG, Dubendorf (CH); Yuxuan WANG, Zürich (CH); Christopher Richard SCHROERS, Uster (CH); Abdelaziz DJELOUAH, Zürich (CH)

(21) Appl. No.: 19/212,236

(22) Filed: May 19, 2025

Related U.S. Application Data
(60) Provisional application No. 63/649,286, filed on May 17, 2024.

(51) Int. Cl. G06T 5/70; G06T 5/60

(52) U.S. Cl. CPC G06T 5/70; G06T 5/60; G06T 2207/10016; G06T 2207/20084

(57) ABSTRACT

Embodiments of the present disclosure provide techniques for restoring video content. An example method generally includes receiving a set of input video frames that include artifacts, generating one or more conditioning features based on the set of video frames, wherein the conditioning features represent content information included in the set of video frames while reducing representation of the artifacts, denoising, using a latent diffusion model and based on the conditioning features, a representation of the set of input video frames that includes noise, and generating a set of output frames based on the denoised representation, wherein the set of output video frames include fewer artifacts relative to the set of input video frames.

### CROSS-REFERENCE TO RELATED APPLICATIONS

This application claims benefit of and priority to U.S. Provisional Patent Application Ser. No. 63/649,286, entitled “Techniques for Video Quality Enhancement with Latent Diffusion Models,” filed May 17, 2024, and assigned to the assignee hereof, the entire contents of which are hereby incorporated by reference.

### BACKGROUND

### Field of the Various Embodiments

Embodiments of the present disclosure relate generally to video processing and, more specifically, to techniques for temporally consistent video restoration using latent diffusion models.

### Description of the Related Art

Video quality enhancement aims to improve visual details from

low-quality (LQ) videos while removing distorted artifacts, such as noise, blur, and compression artifacts etc. Compared to the synthetic data with specialized degradation, the real-world LQ videos are more challenging where the underlying degradation process is often more complicated and stochastic. To improve perceptual realism, recent research attempts to leverage the pretrained generative vision models, including generative adversarial network (GAN) and latent diffusion models. With the aid of richer prior knowledge of texture and semantics from large-scale datasets and models, these methods elevate the perceptual quality to a higher standard. However, the generative capability of these methods is deficient for video restoration tasks in at least two ways. First, the excessive visual details compromise the fidelity of the corresponding high-quality videos and, second, maintaining pixel-level temporal consistency becomes more demanding.

Thus, what is needed in the art are more effective techniques for video restoration using generative models.

### SUMMARY

One embodiment of the present disclosure sets forth techniques for receiving a set of input video frames that include artifacts, generating one or more conditioning features based on the set of video frames, wherein the conditioning features represent content information included in the set of video frames while reducing representation of the artifacts, denoising, using a latent diffusion model and based on the conditioning features, a representation of the set of input video frames that includes noise, and generating a set of output frames based on the denoised representation, wherein the set of output video frames include fewer artifacts relative to the set of input video frames.

One technical advantage of the disclosed techniques is that the disclosed techniques allow for reconstructing video content with visual realism, source fidelity, and temporal consistency. The disclosed techniques directly addresses the non-trivial challenge of preserving the temporal consistency across frames when adapting image diffusion models to degraded videos. This is achieved through key components: the incorporation of temporal modules into the denoising U-Net to enhance temporal consistency within individual video segments and enabling pixel-level fine-grained control, providing a robust spatial-temporal prior from the low quality input video frames to guide generation.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 illustrates a pipeline for temporally-consistent video restoration, according to some embodiments.

FIG. 3 is a detailed illustration of a VP adapter, according to some embodiments.

FIG. 4 illustrates example operations for generating temporally-consistent video frames using a latent diffusion model architecture, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### Overview

Video quality enhancement is a critical task aiming to improve visual details in low-quality (LQ) videos and remove distorted artifacts such as noise, blur, and compression artifacts. The specific objective of video super-resolution is to render high-quality videos from degraded LQ sequences.

Classical methods for video quality enhancement typically involved explicitly modeling and tackling common degradations like upsampling, denoising, and de-blurring. However, these approaches suffer from an inductive bias over the degradation process, which deteriorates their performance on real-world LQ videos where the underlying degradation is often more complicated, random, and composite.

To improve perceptual realism, other approaches use pretrained generative vision models, including Generative Adversarial Networks (GANs) and latent diffusion models (LDMs). With the aid of richer prior knowledge of texture and semantics gained from large-scale datasets and models, these generative methods have elevated the perceptual quality of restored images. In particular, LDMs have demonstrated impressive capability in restoring high-frequency visual details in low-quality image inputs.

However, adapting large latent diffusion models (LDMs) to degraded videos remains a significant challenge. A key difficulty is preserving temporal consistency across frames, which is a non-trivial task given the intrinsic stochastic nature of LDMs and limited computing resources. In particular, achieving pixel-level temporally coherent content across frames is particularly challenging.

Various approaches have been explored for adapting image diffusion models to video generation tasks, including computing cross-frame attention or incorporating additional layers along the temporal axis. However, cross-frame attention can have significant memory requirements given the pixel scales across multiple high-resolution frames. Other zero-shot methods utilizing pretrained priors, such as cross-frame spatial attention, latent warping, and fusion with optical flow estimation, usually require intensive memory and a deliberated design of the sampling process.

A guidance network, such as ControlNet, has become a prevalent choice in recent diffusion-based image restoration frameworks for constraining generation using spatial conditions. While ControlNet can capture and encode content and texture, and its architecture is beneficial when conditioning and generated images should have the same geometry and structures, the ControlNet lacks the capability for pixel-level controllable generation, which is considered essential for certain tasks requiring fine-grained control.

Furthermore, a significant challenge in diffusion-based restoration is an input domain gap observed between training and inference. While training involves predicting noise from HQ latent representations, inference often begins with pure Gaussian noise. This discrepancy can lead diffusion-based super resolution (SR) models to intentionally over-hallucinate details, deviating from realistic content and compromising fidelity. Existing approaches attempt to alleviate this by incorporating source information or embedding LQ latent representations into the initial noise, or by replacing/blending HQ latent estimation with LQ latent representations at early stages. However, these approaches still face challenges: the input domain discrepancy is narrowed but still exists, and may introduce artifacts when the LQ input is severely degraded. Additionally, LDMs may misperceive the noise and artifacts from the LQ input as content and texture, resulting in amplified artifacts and less pleasant content.

Therefore, there remains a need for an improved video restoration framework that effectively adapts the powerful generative priors of latent diffusion models to achieve high visual realism, source fidelity, and robust temporal consistency when dealing with degraded real-world video inputs.

A diffusion-based pipeline designed for reconstructing low-quality (LQ) video into content that is both visually appealing and temporally consistent is disclosed below. The framework leverages the generative prior of a pre-trained latent diffusion model (LDM). The objective is to reconstruct spatial texture details and faithful structure, while also achieving pixel-level temporally coherent content across frames.

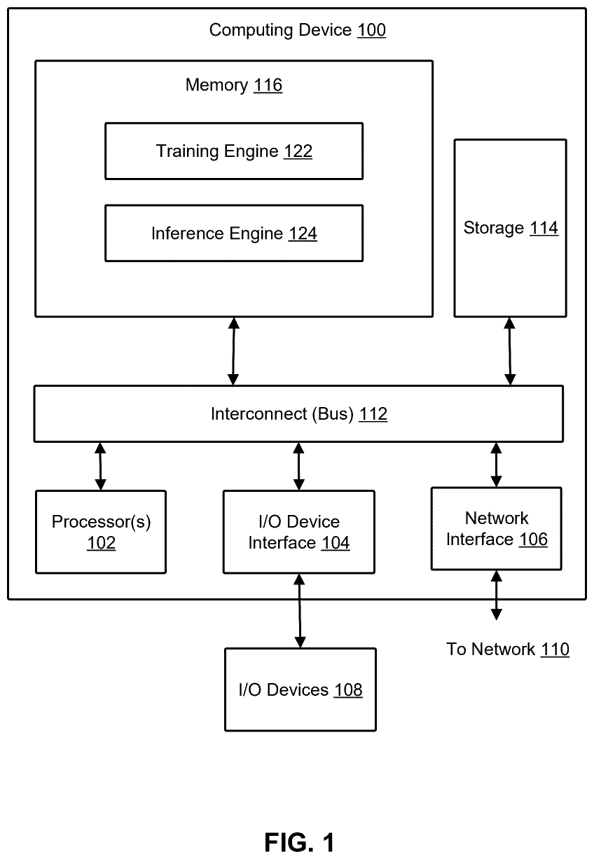

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an inference engine 124 that reside in a memory 116.

It is noted that the computing device described herein is illustrative and that any other technically feasible configurations fall within the scope of the present disclosure. For example, multiple instances of training engine 122 or inference engine 124 could execute on a set of nodes in a distributed and/or cloud computing system to implement the functionality of computing device 100. In another example, training engine 122 or inference engine 124 could execute on various sets of hardware, types of devices, or environments to adapt training engine 122 or inference engine 124 to different use cases or applications. In a third example, training engine 122 or inference engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and inference engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 or inference engine 124.

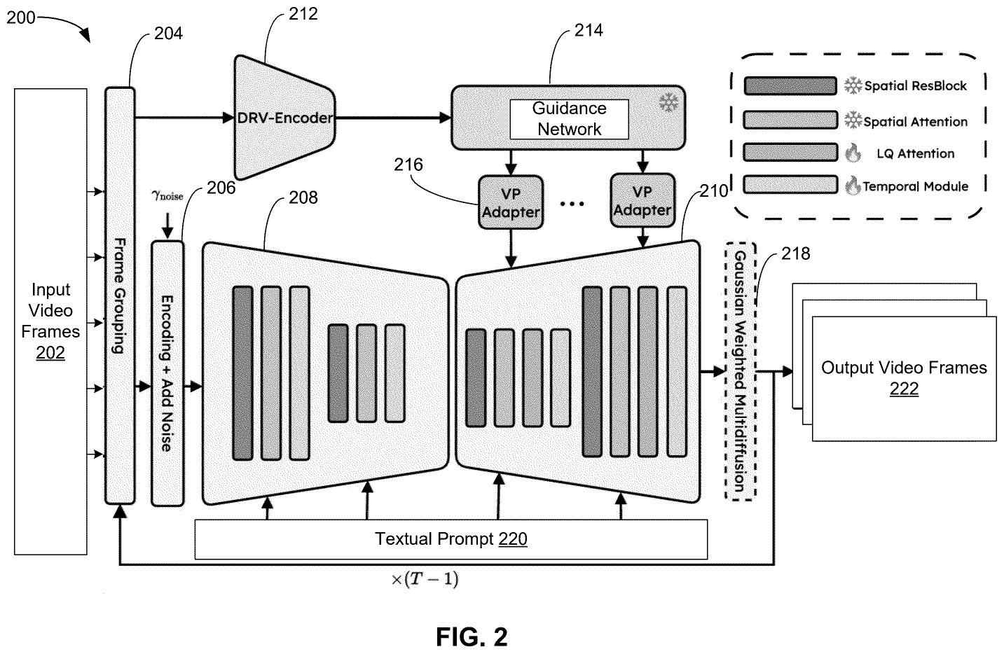

FIG. 2 illustrates a pipeline 200 for temporally-consistent video restoration, according to some embodiments. The pipeline 200 may be trained, for example, on the training engine 122 and may be executed, for example, on the inference engine 124. The pipeline 200 includes frame grouping 204, an encoder 206, a denoising U-Net of a latent diffusion model (LDM) 208-210, a degradation-robust video encoder (DRV-encoder) 212, a guidance network 214, one or more video prompt (VP) adapters 216, and a Gaussian weighted multidiffusion 218.

Given a series of distorted or low-quality (LQ) input video frames 202,

$${( {\tilde{I}}^{k} )}_{k = 1}^{K} ,$$

the pipeline 200 leverages the generative prior of the pre-trained LDM to render high-quality and temporal consistent output video frames 222. The pipeline 200 not only reconstructs spatial texture details and faithful structure, but also pixel-level temporally coherent content across frames. The pipeline 200 implements a diffusion-based reconstruction process. In general, given a noisy latent zₜ and a timestep t in the diffusion process, a latent diffusion model is capable to predict the underlying noise conditioned on the text prompt cₜₑₓₜ. Under the scenario of video restoration, the denoising process is constrained by the input LQ sequence [symbol] . Therefore, pipeline 200 is optimized during training with the objective:

$$ℒ = {𝔹}_{ϵ ∼ 𝒩 ( 0 , I )} [ {‖ {ϵ}_{θ} ( {z}_{t}^{1 : k} , {\hat{I}}_{t}^{1 : k} , t , {c}_{text} ) - ϵ ‖}_{2}^{2} ]$$

In operation, frame grouping 204 organizes the input frames 202 into possibly overlapping groups or batches. In various embodiments, the amount of temporal overlap across groups is set via a hyperparameter during the training phase of the pipeline 200 and via a configuration during the inference phase of the pipeline 200. The groups of frames are denoised separately at each timestep. In various embodiments, to enhance temporal consistency across different frame groups and enable global consistency, a dilated grouping strategy is used. This strategy collects and assembles frames at varying dilation into frame groups within different timesteps.

For a given group of frames, the encoder 206 encodes the group of frames into a latent space of a pre-trained latent diffusion model. In various embodiments, the encoder 206 is a pretrained autoencoder, e.g., a variational autoencoder. The encoder 206 also adds a Gaussian noise parameter to the encoded representation of the group of frames. During inference, following the adjustable noise schedule (ANS) scheme, the noise level parameter interpolates between the pure random noise and LQ embedded noise, which allows users to trade-off between fidelity and realism. The noise level is computed as:

$${x}_{T} ( {γ}_{noise} ) = \sqrt{\tilde{α} ( 1 - {γ}_{noise} )} {\tilde{x}}_{0} + \sqrt{( 1 - \tilde{α} ) {γ}_{noise}} ϵ$$

The encoded representation of the group of frames is transmitted to the latent diffusion model 208-210. The latent diffusion model 208-210 is a U-Net architecture that implements a temporal-aware denoising unit. The U-Net architecture is trained to denoise the encoded representation and generate a set of output video frames 222 that are guided by temporal features and degradation robust image features generated via the DRV-encoder 212 pathway discussed below.

More specifically, the groups of frames are also processed by the degradation-robust video encoder (DRV-encoder) 212. The DRV-encoder 212 addresses a significant challenge in diffusion-based restoration, where Latent Diffusion Models (LDMs) can misperceive noise and artifacts present in the LQ input frames as actual content and texture, potentially resulting in amplified artifacts and less desirable output. The DRV-encoder 212 eliminates these unwanted noise and artifacts from the input while simultaneously preserving and extracting essential content information into latent features. In various embodiments, the DRV-encoder 212 leverages the pretrained VAE encoder of the LDM. To specifically handle video inputs, the DRV-encoder 212 incorporates temporal residual blocks positioned between the pretrained spatial blocks of the VAE encoder. These temporal blocks are included to enhance the capture of temporal characteristics and mitigate degradations specific to video.

During training, the DRV-encoder 212 is supervised to reconstruct high-quality (HQ) content from the corresponding LQ inputs. This supervision occurs in both pixel space and feature space. Specifically, the LQ input video frames 202 are encoded by the DRV-encoder and then decoded into pixel space using a frozen VAE decoder. The encoder and decoder reconstruct the HQ frames using L1 and LPIPS loss functions:

$${ℒ}_{recon} = {\sum }_{k = 1}^{K} ( {ℒ}_{{t}_{1}} + {ℒ}_{LMPS} ) ( 𝒟 ( {ℰ}_{DR} ( {\tilde{I}}^{k} ) ) , {I}^{k} )$$

Further, the DRV-encoder 212 employs knowledge distillation to maintain information aligned with the HQ content across its layers. This is achieved by using a frozen 2D VAE encoder as a teacher network and supervising the training of the DRV-encoder 212 based on the difference between its output and the teacher network's output.

The latent representations produced by the DRV-encoder 212, being more degradation-robust than direct LQ video frame latent representations, are facilitated to eliminate unwanted artifacts. These conditioned maps from the DRV-encoder 212 are then passed through the guidance network 214 and video prompt adapters 216, described below. This process allows the model to capture and encode more texture and semantics from the LQ input video frames 202, enabling pixel-level fine-grained control during the diffusion process. Furthermore, the latent representations generated by the DRV-encoder 212 are crucial for an efficient fine-tuning scheme that helps to bridge the input domain gap and improve fidelity, particularly by providing an “input residual” term derived from the difference between DRV-encoder latent representations and HQ latent representations at early denoising steps.

In various embodiments, the guidance network 214 is a neural network that generates conditioning features that guide the latent diffusion model 208-210 to generate images that adhere closely to the provided structural or spatial information, resulting in outputs that align more accurately with the user's intent. An example of a guidance network 214 is ControlNet, the implementation of which can be found in Lvmin Zhang, Anyi Rao, and Maneesh Agrawala. 2023, “Adding Conditional Control to Text-to-Image Diffusion Models.”

A VP adapter 216 is an adapter network that constrains the generative prior of the latent diffusion model so that the frames generated by the latent diffusion model are guided by the LQ input video frames 202. The VP Adapter 216 operates in conjunction with the guidance network 214 to embed information from the LQ input video frames 202 into the denoising process. In operation, the intermediary conditioning features output from the guidance network 214 are processed through several layers of the VP adapter 216 before being integrated as “video prompts” or conditioning features into the diffusion model 208-210.

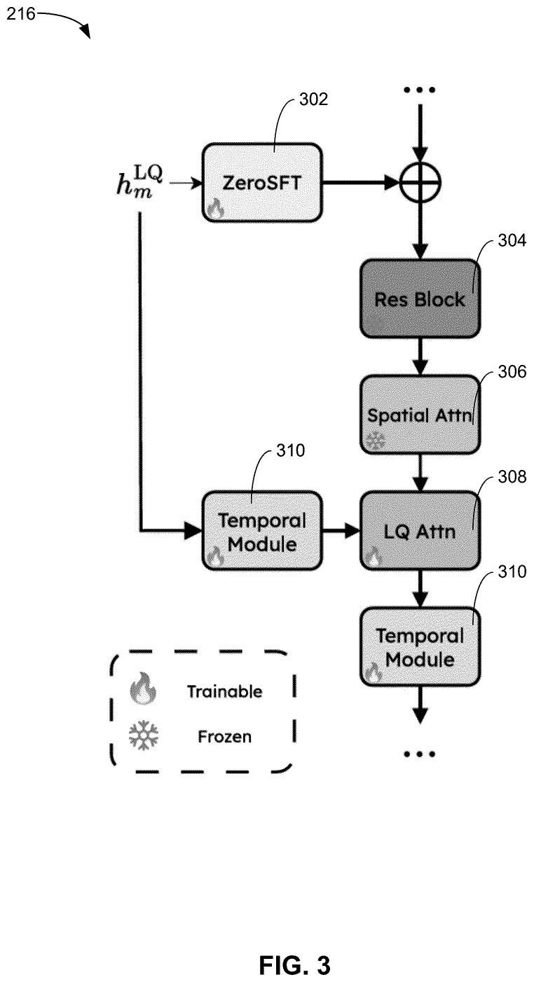

FIG. 3 is a detailed illustration of a VP adapter 216, according to some embodiments. As shown, the VP adapter 216 includes a Zero-initialized Scale-and-Shift Feature Transform (ZeroSFT) layer 302, a residual block layer 304, a spatial attention layer 306, a LQ attention layer 308, and temporal attention modules 310. Some of these layers of the VP adapter 216 are also included in the latent diffusion model 208-210.

By combining these components, the VP Adapter 216 addresses the limitations of the guidance network 214 that potentially lacks the capability for precise pixel-level controllable generation, a feature essential for video restoration. The VP adapter 216 enables the latent diffusion model 208-210 to capture and encode more texture and semantics from the LQ input video frames 202 and facilitates pixel-level fine-grained control during the denoising process. It also aids in recognizing and removing artifacts from the LQ input video frames 202 that the generative process might otherwise misperceive as textures or structures. The intuition is that these components leverage the consecutive LQ frames as a series of “video prompts” to guide the generation process at each denoising step in conjunction with the textual prompt 220.

The ZeroSFT layer 302 is an adaptation of the method described in Fanghua Yu, Jinjin Gu, Zheyuan Li, Jinfan Hu, Xiangtao Kong, Xintao Wang, JingwenHe, Yu Qiao, and Chao Dong. 2024, “Scaling Up to Excellence: Practicing ModelScaling for Photo-Realistic Image Restoration In the Wild,” which is incorporated herein by reference. ZeroSFT builds upon the concept of zero convolution layers, which are initialized with zero weights to prevent unintended alterations to pretrained models during initial training phases. ZeroSFT effectively injects LQ image information into the generative process, ensuring that the restored output maintains structural integrity and aligns closely with the original content. In the VP Adapter 216, ZeroSFT layer 302 is employed before integrating the conditioning features into the latent diffusion model 208-210.

The LQ attention layer 308 calculates cross-attention between the features from the latent diffusion model 208-210 and the conditioning features processed in the VP adapter 216. The conditioning features used by the LQ attention layer 308 are passed through the temporal attention module 310. The temporal attention modules 310 capture the temporal relationship between the spatial conditions derived from the LQ input video frames 202 and captured in the conditioning features.

Returning back to FIG. 2, the video prompts generated by the VP adapters 216 are provided to the latent diffusion model 208-210. As discussed above, the latent diffusion model 208-210 is a U-Net architecture with the additional LQ attention layers 308 and the temporal attention modules 310 described in conjunction with the VP adapters 216. The latent diffusion model 208-210 generates output overlapping video frames that are stitched together by the Gaussian weighted multidiffusion 218 while reducing visible seams or artifacts. In such a manner, the generative prior of the pre-trained latent diffusion model is used to render high-quality and temporal consistent output video frames 222.

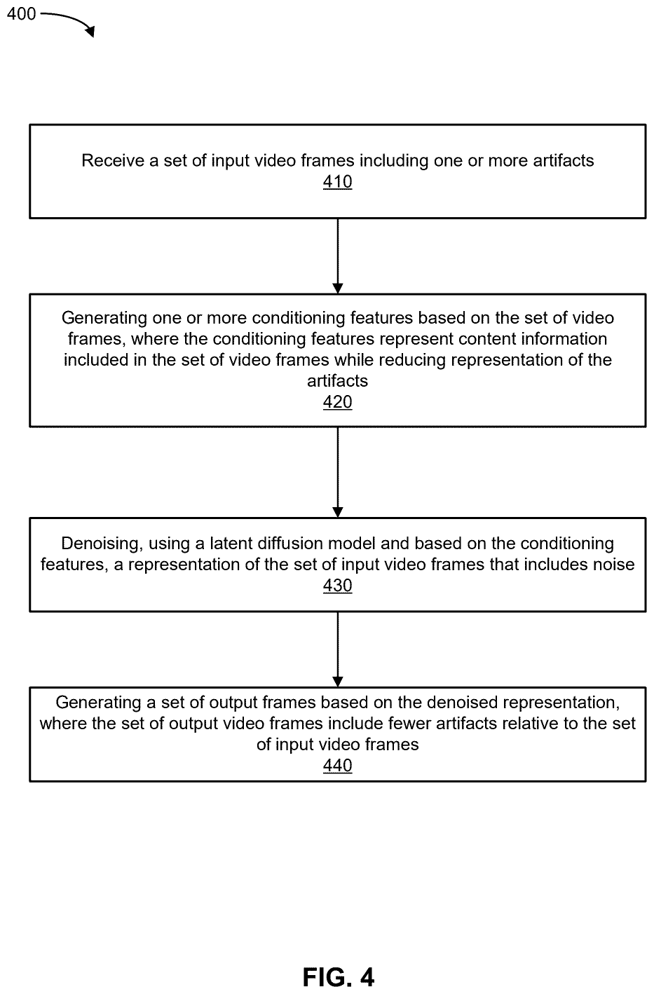

FIG. 4 is a flow diagram illustrating operations 400 for generating temporally-consistent video frames using a latent diffusion model architecture, according to some embodiments. The operations 400 may be performed, for example, by a computing device including one or more processors on which an inferencing engine 124 illustrated in FIG. 1 can execute, such as a desktop computer, a server, a cluster of computing devices, one or more cloud compute instances, or the like.

As illustrated, operations 400 begin at block 410, where inferencing engine 124 receives a set of input video frames that include one or more artifacts. At block 420, operations 400 proceed with inferencing engine 124 generating one or more conditioning features based on the set of video frames, where the conditioning features represent content information included in the set of video frames while reducing representation of the artifacts. At block 430, operations 400 proceed with inferencing engine 124 denoising, using a latent diffusion model and based on the conditioning features, a representation of the set of input video frames that includes noise. At block 440, operations 400 proceed with inferencing engine 124 generating a set of output frames based on the denoised representation, where the set of output video frames include fewer artifacts relative to the set of input video frames.

### Example Clauses

Various embodiments of the present disclosure are described in the following numbered clauses:

CLAUSE 1. A processor-implemented method, comprising: receiving a set of input video frames that include artifacts; generating one or more conditioning features based on the set of video frames, wherein the conditioning features represent content information included in the set of video frames while reducing representation of the artifacts; denoising, using a latent diffusion model and based on the conditioning features, a representation of the set of input video frames that includes noise; an generating a set of output frames based on the denoised representation, wherein the set of output video frames include fewer artifacts relative to the set of input video frames.

CLAUSE 2. The method of clause 1, wherein generating the one or more conditioning features comprises encoding the set of input video frames into an encoded representation with an encoder that is trained to preserve the content information included in the set of video frames.

CLAUSE 3. The method of clause 1 or 2, wherein generating the one or more conditioning features comprises processing the encoded representation to generate intermediary conditioning features.

CLAUSE 4. The method of any of clauses 1-3, wherein generating the one or more conditioning features comprises processing the intermediary conditioning features based on one or more temporal characteristics associated with the set of input video frames and one or more content characteristics associated with the set of input video frames.

CLAUSE 5. The method of any of clauses 1-4, wherein the latent diffusion model includes one or more temporal layers that account for temporal characteristics of the set of input video frames.

CLAUSE 6. The method of any of clauses 1-5, further comprising generating the representation of the set of input video frames based on a latent space of the latent diffusion model.

CLAUSE 7. The method of any of clauses 1-6, wherein the conditioning features further represent one or more temporal characteristics of the set of input video frames.

CLAUSE 8. One or more non-transitory computer readable media that, when executed by one or more computing devices, cause the one or more computing devices to perform the steps of: receiving a set of input video frames that include artifacts; generating one or more conditioning features based on the set of video frames, wherein the conditioning features represent content information included in the set of video frames while reducing representation of the artifacts; denoising, using a latent diffusion model and based on the conditioning features, a representation of the set of input video frames that includes noise; and generating a set of output frames based on the denoised representation, wherein the set of output video frames include fewer artifacts relative to the set of input video frames.

CLAUSE 9. The one or more non-transitory computer readable of clause 8, wherein generating the one or more conditioning features comprises encoding the set of input video frames into an encoded representation with an encoder that is trained to preserve the content information included in the set of video frames.

CLAUSE 10. The one or more non-transitory computer readable of clause 8 or 9, wherein generating the one or more conditioning features comprises processing the encoded representation to generate intermediary conditioning features.

CLAUSE 11. The one or more non-transitory computer readable of any of clauses 8-10, wherein generating the one or more conditioning features comprises processing the intermediary conditioning features based on one or more temporal characteristics associated with the set of input video frames and one or more content characteristics associated with the set of input video frames.

CLAUSE 12. The one or more non-transitory computer readable of any of clauses 8-12, wherein the latent diffusion model includes one or more temporal layers that account for temporal characteristics of the set of input video frames.

CLAUSE 13. The one or more non-transitory computer readable of any of clauses 8-13, further comprising generating the representation of the set of input video frames based on a latent space of the latent diffusion model.

CLAUSE 14. The one or more non-transitory computer readable of any of clauses 8-14, wherein the conditioning features further represent one or more temporal characteristics of the set of input video frames.

CLAUSE 15. A processing system, comprising: at least one memory having executable instructions stored thereon; and one or more processors configured to execute the executable instructions to cause the processing system to: receive a set of input video frames that include artifacts; generate one or more conditioning features based on the set of video frames, wherein the conditioning features represent content information included in the set of video frames while reducing representation of the artifacts; denoise, using a latent diffusion model and based on the conditioning features, a representation of the set of input video frames that includes noise; and generate a set of output frames based on the denoised representation, wherein the set of output video frames include fewer artifacts relative to the set of input video frames.

CLAUSE 16. The processing system of clause 15, wherein generating the one or more conditioning features comprises encoding the set of input video frames into an encoded representation with an encoder that is trained to preserve the content information included in the set of video frames.

CLAUSE 17. The processing system of clause 15 or 16, wherein generating the one or more conditioning features comprises processing the encoded representation to generate intermediary conditioning features.

CLAUSE 18. The processing system of any of clauses 15-17, wherein generating the one or more conditioning features comprises processing the intermediary conditioning features based on one or more temporal characteristics associated with the set of input video frames and one or more content characteristics associated with the set of input video frames.

CLAUSE 19. The processing system of any of clauses 15-18, wherein the latent diffusion model includes one or more temporal layers that account for temporal characteristics of the set of input video frames.

CLAUSE 20. The processing system of any of clauses 15-19, further comprising generating the representation of the set of input video frames based on a latent space of the latent diffusion model.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor-implemented method, comprising:
receiving a set of input video frames that include artifacts;
generating one or more conditioning features based on the set of video frames, wherein the conditioning features represent content information included in the set of video frames while reducing representation of the artifacts;
denoising, using a latent diffusion model and based on the conditioning features, a representation of the set of input video frames that includes noise; and
generating a set of output frames based on the denoised representation, wherein the set of output video frames include fewer artifacts relative to the set of input video frames.

2. The method of claim 1, wherein generating the one or more conditioning features comprises encoding the set of input video frames into an encoded representation with an encoder that is trained to preserve the content information included in the set of video frames.

3. The method of claim 2, wherein generating the one or more conditioning features comprises processing the encoded representation to generate intermediary conditioning features.

4. The method of claim 3, wherein generating the one or more conditioning features comprises processing the intermediary conditioning features based on one or more temporal characteristics associated with the set of input video frames and one or more content characteristics associated with the set of input video frames.

5. The method of claim 1, wherein the latent diffusion model includes one or more temporal layers that account for temporal characteristics of the set of input video frames.

6. The method of claim 1, further comprising generating the representation of the set of input video frames based on a latent space of the latent diffusion model.

7. The method of claim 1, wherein the conditioning features further represent one or more temporal characteristics of the set of input video frames.

8. One or more non-transitory computer readable media that, when executed by one or more computing devices, cause the one or more computing devices to perform the steps of:
receiving a set of input video frames that include artifacts;
generating one or more conditioning features based on the set of video frames, wherein the conditioning features represent content information included in the set of video frames while reducing representation of the artifacts;
denoising, using a latent diffusion model and based on the conditioning features, a representation of the set of input video frames that includes noise; and
generating a set of output frames based on the denoised representation, wherein the set of output video frames include fewer artifacts relative to the set of input video frames.

9. The one or more non-transitory computer readable of claim 8, wherein generating the one or more conditioning features comprises encoding the set of input video frames into an encoded representation with an encoder that is trained to preserve the content information included in the set of video frames.

10. The one or more non-transitory computer readable of claim 9, wherein generating the one or more conditioning features comprises processing the encoded representation to generate intermediary conditioning features.

11. The one or more non-transitory computer readable of claim 10, wherein generating the one or more conditioning features comprises processing the intermediary conditioning features based on one or more temporal characteristics associated with the set of input video frames and one or more content characteristics associated with the set of input video frames.

12. The one or more non-transitory computer readable of claim 8, wherein the latent diffusion model includes one or more temporal layers that account for temporal characteristics of the set of input video frames.

13. The one or more non-transitory computer readable of claim 8, further comprising generating the representation of the set of input video frames based on a latent space of the latent diffusion model.

14. The one or more non-transitory computer readable of claim 8, wherein the conditioning features further represent one or more temporal characteristics of the set of input video frames.

15. A processing system, comprising:
at least one memory having executable instructions stored thereon; and
one or more processors configured to execute the executable instructions to cause the processing system to:
receive a set of input video frames that include artifacts;
generate one or more conditioning features based on the set of video frames, wherein the conditioning features represent content information included in the set of video frames while reducing representation of the artifacts;
denoise, using a latent diffusion model and based on the conditioning features, a representation of the set of input video frames that includes noise; and
generate a set of output frames based on the denoised representation, wherein the set of output video frames include fewer artifacts relative to the set of input video frames.

16. The processing system of claim 15, wherein generating the one or more conditioning features comprises encoding the set of input video frames into an encoded representation with an encoder that is trained to preserve the content information included in the set of video frames.

17. The processing system of claim 16, wherein generating the one or more conditioning features comprises processing the encoded representation to generate intermediary conditioning features.

18. The processing system of claim 17, wherein generating the one or more conditioning features comprises processing the intermediary conditioning features based on one or more temporal characteristics associated with the set of input video frames and one or more content characteristics associated with the set of input video frames.

19. The processing system of claim 15, wherein the latent diffusion model includes one or more temporal layers that account for temporal characteristics of the set of input video frames.

20. The processing system of claim 15, further comprising generating the representation of the set of input video frames based on a latent space of the latent diffusion model.
